(19) United States
(12) Patent Application Publication
(10) Pub. No.: US 2010/0007281 A1
(43) Pub. Date: Jan. 14, 2010

(54) METHOD OF LIGHTING GAS DISCHARGE LAMP

(76) Inventors: Hui-Hsiang Feng, Hu-Kou (TW); Ya-Chuan Yeh, Hu-Kou (TW)

Correspondence Address: LEONG C LEI, PMB # 1008, 1867 YGNACIO VALLEY ROAD, WALNUT CREEK, CA, 94598, US

(21) Appl. No.: 12/170,439

(22) Filed: Jul. 10, 2008

(51) Int. Cl. G09G 3/00

(52) U.S. Cl. 315/169.1

(57) ABSTRACT

The present invention lights a gas discharge lamp with a stable average frequency and in the mean time grows tips evenly on the two electrodes of the gas discharge lamp so that the distance between the electrodes is maintained and the stability of the electric arc is enhanced. The present invention first applies a DC voltage and then a high-frequency AC voltage to the electrodes of the gas discharge lamp. The present invention then applies a reversed DC voltage and then a high-frequency AC voltage to the electrodes. This process is repeated and, as the tungsten ions in the electric arc are steadily deposited on the arc spots of the electrodes alternately and two tips are thereby evenly developed on the first and second electrodes, respectively.

### (a) TECHNICAL FIELD OF THE INVENTION

The present invention generally relates to gas discharge lamps, and more particularly to a method of lighting a gas discharge lamp capable of producing a more stable electric arc.

### (b) DESCRIPTION OF THE PRIOR ART

For a gas discharge lamp, a shorter distance between the electrodes would contribute to a more stable electric arc. However, as the material used for the electrodes would evaporate under the high temperature of the electric arc, the distance between the electrodes would gradually increase as the gas discharge lamp is put to use. For example, the electrodes of an Ultra High Performance (UHP) mercury lamp commonly found in a modem projector are often made of tungsten, which is well-known for its high melting point and low vapor pressure. Even as such, the tungsten electrodes of an UHP mercury lamp would still suffer the fast evaporation described above. The increased distance between the electrodes would contribute to a higher operational voltage, a higher current, a higher power consumption, a higher heat load and thereby a higher temperature for the electrodes. The electrodes would therefore evaporate even faster. The overall consequence is that the gas discharge lamp would have a shorter operational life span.

For a conventional gas discharge lamp, the arc spot (i.e., where the electrode contacts the electric arc) has a diameter about 0.1˜0.2 nm and a temperature around 5000° K. Under such a high temperature, as mentioned earlier, tungsten would quickly evaporate. However, the vaporized tungsten would be condensed and deposited in a low-temperature area of the electrode, thereby forming a pointed tip. Due to its sharpness, the tip would become another arc spot and the tungsten would begin to be deposited in another area. As such, the electric arc would be jumping around the roughened surface of the electrode as the distance between the electrodes increases.

If the vaporized tungsten could be condensed back to a single and same location on the electrode, the distance between the electrodes would be under control and the stability of the electric arc could be improved.

The company Philips has disclosed one such solution. According to the teaching, a voltage pulse is applied to the electrodes of a gas discharge lamp. At the instant when the polarity of the voltage changes, the temperature of the arc spot on the positive electrode rises abruptly as the current sharply increases. Then, after the polarity is changed, the arc spot on the now negative electrode would become an ideal electron emission point (as it has the appropriately high temperature) and a most stable place for the electric arc to land. The tungsten ions would continuously be deposited there and, after a period of time, a tip would be developed from the surface of the electrodes and the distance between the electrodes is thereby not continuously increasing. The stability of the electric arc is enhanced as such.

A Japanese company Ushio has taught another solution in which the gas discharge lamp is driven by a high-frequency signal and a low-frequency signal alternately. Initially, the high-frequency signal is applied and the electrodes of the gas discharge lamp would reach comparable temperature. Then, the low-frequency signal is applied where the positive electrode is given more time to receive electrons and its arc spot is able to develop a high temperature. Then, after the polarity changes, the electrons would be discharged from where the temperature is the highest of the negative electrode and a stable arc spot is achieved. In the mean time, tungsten ions would be steadily deposited on the arc spot and, after a period of time, two stable tips would be developed on the electrodes and the distance between the electrodes is maintained. Compared to the Philips' method, the Ushio method allows tips to be developed appropriately. However, its adoption of signals of different frequencies is appropriate for use in a Liquid Crystal Display (LCD) projection system, but not in a Digital Lighting Processing (DLP) projection system. The reason is that the latter has compatibility issues with the rotational speeds of the color wheel and the micromirrors of the Digital Micromirror Device (DMD) chip, and a stable lighting frequency is required.

### SUMMARY OF THE INVENTION

A novel method of lighting a gas discharge lamp is disclosed herein. A major purpose of the present invention is to grow tips evenly on the two electrodes of the gas discharge lamp so that the distance between the electrodes is maintained or even reduced, and the stability of the electric arc is enhanced. Another major purpose of the present invention is that the method is applicable to both a LCD projection system and a DLP projection system.

According to the thermal electron emission principle, when the gas discharge lamp is lit electrons are emitted from where the temperature is the highest hereinafter, the electron emission point) on the negative electrode. On the other hand, the positive electrode recovers the electrons at where it contacts the electric arc. In other words, the arc spot of the positive electrode is also the electron recovering point and also has the highest temperature. If the polarity of the electrodes is reversed, the arc spot of the current negative electrode, as having the highest temperature, becomes the electronic emission point. The tungsten ions then would be deposited on the arc spot of the negative electrode.

Based on the foregoing principle, The method first applies a direct-current (DC) voltage to light the gas discharge lamp with a first electrode of the gas discharge lamp being the negative electrode and a second electrode as the positive electrode. As the temperature of an arc spot of the second electrode rises to a certain temperature, the method then removes the DC voltage and applies a high-frequency, alternating-current (AC) voltage to light the gas discharge lamp. Since the temperature of the second electrode's arc spot is high enough, the arc spot would be the electron emission point when the second electrode functions as the negative electrode during the application of the AC voltage. After the AC voltage is applied for a period of time and the temperature of the second electrode is not high enough to maintain a stable arc spot the method removes the AC voltage and applies a DC voltage again but with the first electrode as the positive electrode and the second electrode as the negative electrode. The method repeats the foregoing process and, as the tungsten ions in the electric arc are steadily deposited on the arc spots of the electrodes alternately and two tips are thereby evenly developed on the first and second electrodes, respectively. As such, the distance between the first and second electrodes is well under control and the stability of the electric arc is significantly improved.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a flow diagram showing the steps of lighting a gas discharge lamp according to the present invention.

FIG. 2 is a waveform diagram showing the flow of electrons in the gas discharge lamp according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

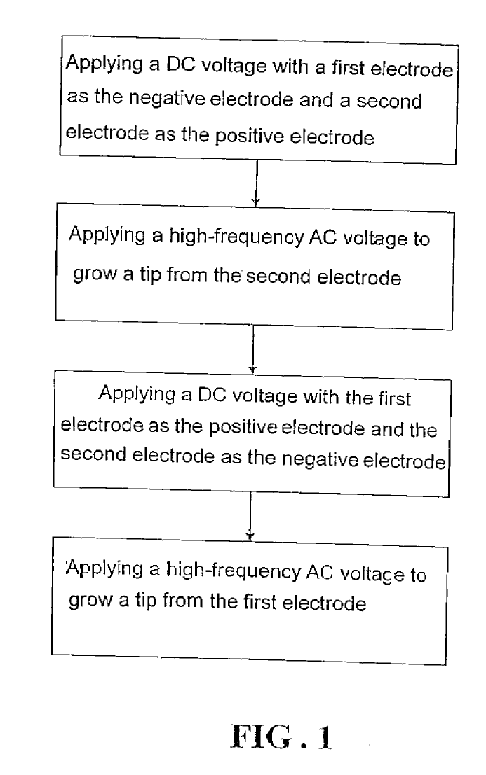

FIG. 1 is a flow diagram showing the steps of lighting a gas discharge lamp according to the present invention. The method first applies a DC voltage to light the gas discharge lamp with a first electrode of the gas discharge lamp being the negative electrode and a second electrode as the positive electrode. As the temperature of an arc spot of the second electrode (i.e., positive electrode) rises to a certain temperature, the method then removes the DC voltage and applies a high-frequency AC voltage to light the gas discharge lamp. Since the temperature of the second electrode's arc spot is high enough, the arc spot would produce electrons steadily when the second electrode functions as the negative electrode during the application of the AC voltage. The tungsten ions in the electric arc are thereby steadily deposited on the arc spot of the second electrode and a tip is developed. After the AC voltage is applied for a period of time and the temperature of the second electrode is not high enough to maintain a stable arc spot, the method removes the AC voltage and applies a DC voltage again but with the first electrode as the positive electrode and the second electrode as the negative electrode. Again, as the temperature of an arc spot of the first electrode (i.e., positive electrode) rises to a certain temperature, the method then removes the DC voltage and applies the high-frequency, alternate-current (AC) voltage to light the gas discharge lamp. Since the temperature of the first electrode's arc spot is high enough, the arc spot would be the electron emission point when the first electrode functions as the negative electrode during the application of the AC voltage. The tungsten ions in the electric arc are thereby steadily deposited on the arc spot of the first electrode and another tip is developed. After the AC voltage is applied for a period of time and the temperature of the first electrode is not high enough to maintain a stable arc spot, the method removes the AC voltage and applied a DC voltage with reversed polarity again (i.e., with the first electrode as the negative electrode and the second electrode as the positive electrode). The method repeats the foregoing process and two tips are evenly developed on the first and second electrodes, respectively. As such, the distance between the first and second electrodes is well under control, and the stability of the electric arc is significantly improved.

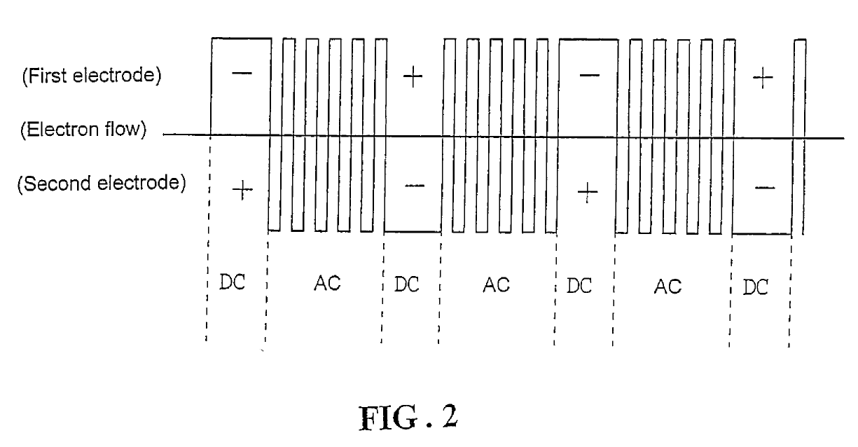

FIG. 2 is a waveform diagram showing the flow of electrons in the gas discharge lamp according to the present invention. This diagram also shows the alternating roles of the first and second electrodes as the positive and negative electrodes when the DC voltage is applied. The high-frequency AC voltage then evenly distributes the tungsten ions on the first and second electrodes, respectively. Two tips are therefore uniformly grown. As such, the distance between the first and second electrodes is maintained and the electric arc in the gas discharge lamp is stabilized. Additionally, from FIG. 2, it should be clear that on the average the gas discharge lamp is driven by a stable frequency and the method therefore could be applied to both a LCD system and a DLP system.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A method of lighting a gas discharge lamp, comprising the steps of:
applying a DC voltage to a first electrode and a second electrode of said gas discharge lamp, with said first electrode as a negative electrode and said second electrode as a positive electrode;
applying a high-frequency AC voltage to said first and second electrodes;
applying a DC voltage to said first and second electrodes, with said first electrode as a positive electrode and said second electrode as a negative electrode; and
applying a high-frequency AC voltage to said first and second electrodes.

2. The method according to claim 1, wherein said high-frequency AC voltage is applied when an arc spot's temperature on a positive electrode reaches a level.

3. The method according to claim 1, wherein said DC voltage is applied when said positive electrode's temperature drops to a level not able to maintain a stable arc spot.

4. The method according to claim 1, wherein said gas discharge lamp is an Ultra High Performance mercury lamp.
